(19) United States
(12) Patent Application Publication
(10) Pub. No.: US 2015/0177193 A1
(43) Pub. Date: Jun. 25, 2015

(54) ULTRASONIC THICKNESS GAUGE WITH INTERFACE TO HAND-HELD INSTRUMENT

(71) Applicants: Jonathan David Murphy, Friday Harbor, WA (US); Scott Brady, Escondido, CA (US); Karl Vietsch, Nieuwegein (NL)

(72) Inventors: Jonathan David Murphy, Friday Harbor, WA (US); Scott Brady, Escondido, CA (US); Karl Vietsch, Nieuwegein (NL)

(21) Appl. No.: 14/502,142

(22) Filed: Sep. 30, 2014

Related U.S. Application Data
(63) Continuation-in-part of application No. 14/136,643, filed on Dec. 20, 2013.

(51) Int. Cl. G01N 29/04

(52) U.S. Cl. CPC G01N 29/04; G01N 2291/045; G01N 2291/102

(57) ABSTRACT

A sensor system, apparatus, and method. The sensor system a mobile unit including a power source, and a sensory head releasably coupled with the mobile unit. The sensory head is in electrical communication with the mobile unit so as to receive power from the power source and to provide a communication signal to the mobile unit. The sensory head includes an ultrasonic thickness sensor configured to generate a signal representing of a thickness of a test piece, and an identification reader configured to obtain data representing an identifier from an identification tag located external to the sensory head. The sensory head also includes a controller coupled with the ultrasonic thickness sensor and the identification reader. The controller is configured to initiate the ultrasonic thickness sensor in response to the identification reader obtaining the data representing the identifier.

### CROSS-REFERENCE TO RELATED APPLICATIONS

This application is a continuation-in-part of U.S. Patent Application Ser. No. 14/136,643, which was filed on Dec. 20, 2013. The entirety of this priority application is incorporated herein by reference.

### BACKGROUND

Ultrasonic thickness gauges are generally employed for non-destructively measuring the thickness of a test piece. Although there are many different kinds of thickness gauges, they basically employ an arrangement of one or more transmitters and one or more receivers. The transmitter causes a sound wave to propagate through the test piece and the receiver detects sound waves that have propagated through the test piece. Some thickness gauges measure echoes, i.e., reflected waves, which are caused when the sound wave encounters an interface between two materials of different propagation speeds. The interface, in such case, may be the opposite side of the test piece from the transmitter. Other arrangements may include positioning the receiver on one side of the material and the transmitter on the other, such that the sound waves are recorded after a one-way trip, i.e., reflections generally are not considered. In either case, in simplified terms, if the speed of propagation of the sound wave in the material being tested is known, and the trajectory of the sound wave (and/or the reflection thereof) is known, then the delay between emitting an ultrasonic pulse and recording the ultrasonic pulse at the receiver may be related to the thickness of the material.

Some ultrasonic thickness gauges are provided in compact, portable packages, which may facilitate mobile use. However, the portability of these gauges is often offset by limitations in the capabilities thereof. Such limitations include computing power, battery life, and display size. One way to address these challenges is to provide more powerful and efficient processors, higher-capacity batteries, and higher-resolution displays. However, a conservation of these resources may be beneficial, for example, from a cost standpoint. Moreover, different types of sensors may be called for in taking different types of measurements (i.e., temperature measurements require a temperature gauge, not a thickness gauge). Thus, users are often forced to carry several different sensors when, for example, conducting a walk-around inspection of an industrial facility.

In addition, the material from which the test piece is constructed, as well as its geometry, surface roughness, internal cracking, etc. may influence sensor calibration and/or sensor selection. Accordingly, calibration, especially when considering multiple different test pieces during a walk-around, may be cumbersome.

### SUMMARY

Embodiments of the disclosure may provide a sensory apparatus for ultrasonic thickness measurement. The apparatus includes an ultrasonic thickness sensor, and an identification reader configured to acquire data representing an identifier from an identification tag. The apparatus also includes a controller coupled with the ultrasonic thickness sensor and the identification reader. In response to the identification reader acquiring the data representing the identifier, the controller causes the ultrasonic thickness sensor to measure a thickness of a test piece.

Embodiments of the disclosure may also provide a sensor system, apparatus, and method. The sensor system a mobile unit including a power source, and a sensory head releasably coupled with the mobile unit. The sensory head is in electrical communication with the mobile unit so as to receive power from the power source and to provide a communication signal to the mobile unit. The sensory head includes an ultrasonic thickness sensor configured to generate a signal representing of a thickness of a test piece, and an identification reader configured to obtain data representing an identifier from an identification tag located external to the sensory head. The sensory head also includes a controller coupled with the ultrasonic thickness sensor and the identification reader. The controller is configured to initiate the ultrasonic thickness sensor in response to the identification reader obtaining the data representing the identifier.

Embodiments of the disclosure may further provide a method for measuring thickness. The method includes coupling a sensory head to a mobile unit such that the sensory head receives at least power from the mobile unit and supplies a communication signal to the mobile unit, wherein the sensory head includes a controller, an identification reader coupled with the controller, and an ultrasonic thickness sensor coupled with the controller. The method also includes obtaining data representing an identifier from an identification tag positioned in, on, or proximal to a test location of a test piece, using the identification reader. Further, the method includes, in response to obtaining the data representing the identifier, taking one or more thickness measurements using the ultrasonic thickness sensor.

### BRIEF DESCRIPTION OF THE DRAWINGS

The accompanying drawings, which are incorporated in and constitutes a part of this specification, illustrates an embodiment of the present teachings and together with the description, serves to explain the principles of the present teachings. In the figures:

FIG. 1A illustrates a schematic, perspective view of a sensor system, according to an embodiment.

FIG. 1B illustrates a schematic view of the sensor system, according to an embodiment.

FIG. 2 illustrates an exploded, perspective view of a sensory head, according to an embodiment.

FIG. 3 illustrates an exploded perspective view of contacts and an isolator ring of the sensory head, according to an embodiment.

FIG. 4 illustrates a perspective view of a shell body of the sensory head, according to an embodiment.

FIG. 5 illustrates a perspective view of a controller of the sensory head, according to an embodiment.

FIG. 6 illustrates an exploded, perspective view of a ultrasonic thickness sensor and a hood of the sensory head, according to an embodiment.

FIG. 7 illustrates a flowchart of a method for sensing a thickness of a test piece, according to an embodiment.

It should be noted that some details of the figures have been simplified and are drawn to facilitate understanding of the embodiments rather than to maintain strict structural accuracy, detail, and scale.

### DETAILED DESCRIPTION

Reference will now be made in detail to embodiments of the present teachings, examples of which are illustrated in the accompanying drawing. In the drawings, like reference numerals have been used throughout to designate identical elements, where convenient. In the following description, reference is made to the accompanying drawing that forms a part thereof, and in which is shown by way of illustration a specific exemplary embodiment in which the present teachings may be practiced. The following description is, therefore, merely exemplary.

In general, embodiments of the present disclosure provide a mobile unit that is electrically and mechanically coupled with a sensory head. The sensory head provides an ultrasonic thickness gauge, as well as an identification reader, such as a radio-frequency identification (RFID) tag reader, to name one example. The reader may be configured to acquire an identifier (e.g., tag number) from an identification tag (e.g., RFID tag) positioned at a predetermined location in, on, or near to a test piece. The identifier may be linked in a database to material properties, calibration information, sensor-selection information, and/or the like, which may be related to the predetermined location of the identification tag. The mobile unit, or a remote computing device (e.g., a ruggedized, hand-held computing device) in communication with the mobile unit, may access the location-specific information, which it may use to calibrate or otherwise analyze measurements taken by the sensory head.

Furthermore, the sensory head may be configured to automatically take ultrasonic thickness measurements in response to reading an identifier from the identification tag. The data collected by the ultrasonic thickness gauge may be transmitted to the mobile unit and/or the remote device for displaying, processing, storage, etc., e.g., in association with the identifier.

The mobile unit may be provided with an electro-mechanical interface with the sensory head. The interface may be configured to support a connection with one or more other, different types of sensors, thereby, for example, providing a modular extensibility for the mobile unit. As such, the interface may allow a user to invest in one portable instrument with multiple sensor heads, which may save money and make walk-around data collection easier and more convenient. Furthermore, the mobile unit may interface with software applications that allow for a consistent user interaction and data sharing across the organizations, while receiving and analyzing input from different types of sensory heads.

Moreover, one advantage of having the sensor and identification reader close together (e.g., co-located in the sensory head) is that the identification tag may be mounted at the measurement location, and the identification tag may be scanned to start the measurement. The sensory head may thus be able to be fed data representing the general physical location of the accessory sensor head and the logical measurement settings and alarm criteria associated with the measurement location. It will be appreciated that these advantages and/or others may be provided in various embodiments of the present disclosure; however, these advantages should not be considered limiting or otherwise required.

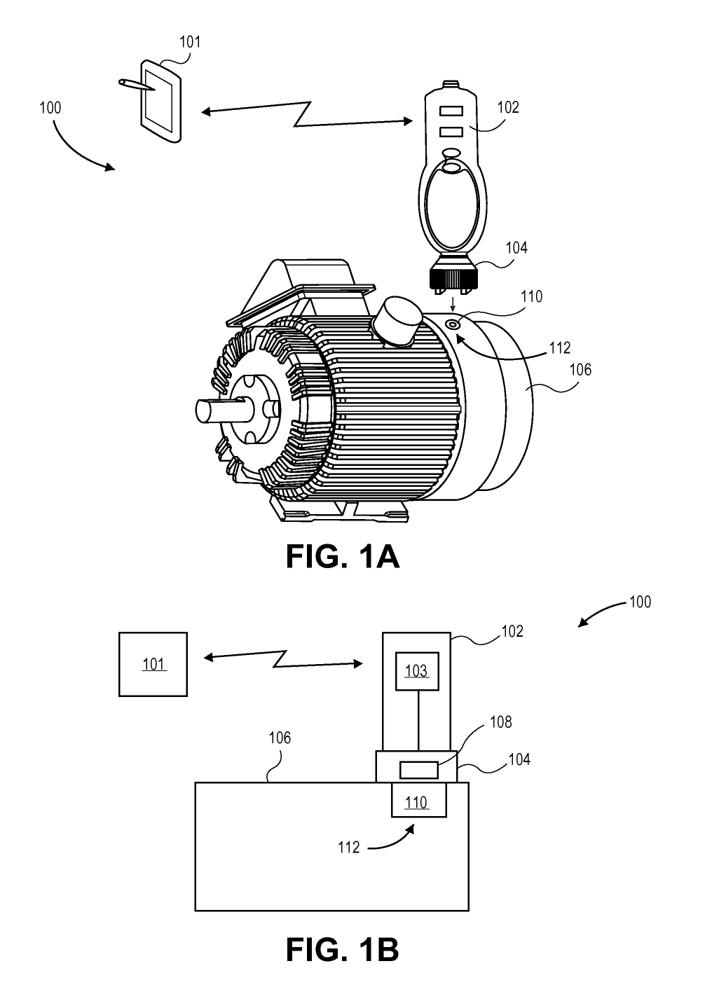

Turning now to the Figures, FIG. 1A illustrates a schematic, perspective view of a sensor system 100, according to an embodiment. FIG. 1B illustrates a simplified, schematic view of the sensor system 100, according to an embodiment. Referring to both FIGS. 1A and 1B, the sensor system 100 may include a mobile unit 102 that is in communication with a remote device 101 and in electrical and mechanical communication with a sensory head 104. The mobile unit 102 may include a power source 103, which may be a battery or a wired connection to an external power source, and may also include various other electrical and/or mechanical components.

The remote device 101 may be a portable electronic device, such as a smartphone, tablet, or laptop computer, or may be another type of specific or general-purpose computing device that is supplied with appropriate software. The mobile unit 102 may communicate with the remote device 101, and, in some embodiments, vice versa, via any suitable communications link, such as a wireless link (e.g., BLUETOOTH®, WiFi, WIMAX®, GSM, CDMA, LTE, etc.).

The sensor system 100 may also include a sensory apparatus or “head” 104 that may be releasably coupled, e.g., mechanically and electrically, with the mobile unit 102 so as to be positionally fixed thereto, receive at least power therefrom, and provide one or more signals thereto. The sensory head 104 may include, for example, an ultrasonic transmitter and an ultrasonic receiver (or a single component providing a combination of these functions). The ultrasonic transmitter may be configured to cause an ultrasonic wave, e.g., in the range of between about 1 MHz and about 5 MHz (although any other frequency range may be employed) to propagate through a test piece 106. The receiver may be configured to detect the ultrasonic waves that have propagated at least partially through the test piece 106.

In at least one embodiment, the mobile unit 102 may include a display screen 105, which may be configured to display data based on the ultrasonic thickness measurements taken using the sensory head 104. In other embodiments, the display screen 105 may be omitted from the mobile unit 102, or may otherwise not display such data.

The test piece 106 may be any portion of a machine, housing, or casing thereof, for example. In at least one specific example, the test piece 106 may be a bearing housing. Accordingly, the sensor system 100, e.g. via the sensory head 104 of the mobile unit 102, may be configured to determine a precise thickness of the test piece 106, which may provide information as to system integrity, health, wear indication, etc.

Further, the sensory head 104 may include an identification reader 108. The identification reader 108 may be configured to capture data representing an identifier, such as a tag number, and/or any other information from an identification tag 110 mounted in, on, or near to, or otherwise disposed proximal to, a test location 112 of the test piece 106.

In some embodiments, the identification reader 108 may be a radio-frequency identification (RFID) tag reader, and the identification tag 110 may be an active or passive RFID tag. As the term is used herein, “tag” broadly refers to any structure positionable at a location in, on, or near to a test piece, and should not be interpreted as requiring any particular size or shape, unless otherwise expressly stated herein. In some embodiments, the tag 110 may be a small, thin structure made of one or several layers of material, which may be adhered to the location 112. In other embodiments, the identification tag 110 may be larger, include other components (such as a processor, display screen, other input and/or output peripherals, etc.), and/or may be incorporated into a larger device. In some embodiments, the identification tag 110 may display a QR code, whether statically (e.g., printed) or dynamically (e.g., displayed on a display screen). In another embodiment, the identification tag 110 may display a bar code, or may provide an identifier to the identification reader 108 through any other medium, such as sound, light (e.g., infrared) pulses, etc. The identification reader 108 may be suitably configured to read the QR code, bar code, or any other identifier transmission medium selected.

The identifier read from the identification tag 110 may be associated with location-specific information, e.g., in a table or database. The database may be stored on the mobile unit 102, on the remote device 101, or on another device communicably coupled with the mobile unit 102 and/or the remote device 101. For example, the location-specific information may include the material composition, surface roughness, geometry, or any other property of the test piece 106 that may assist in selecting a sensor, calibrating the sensor, and/or analyzing the measurement data. In an embodiment, the location-specific information may additionally or instead represent historical thickness measurements at the test location 112. Such historical measurements may facilitate the calculation of measured thickness trends, which may contribute to life-cycle analysis, wear-rate determinations, system health, etc.

The sensory head 104 may be a modular unit, which may be removable from the mobile unit 102. Accordingly, when a different sensor is needed, the sensory head 104 may be removed from the mobile unit 102, and another sensory head attached. This may facilitate switching between different types of ultrasonic thickness sensors, or using different types of sensors, e.g., while testing various equipment in an industrial facility.

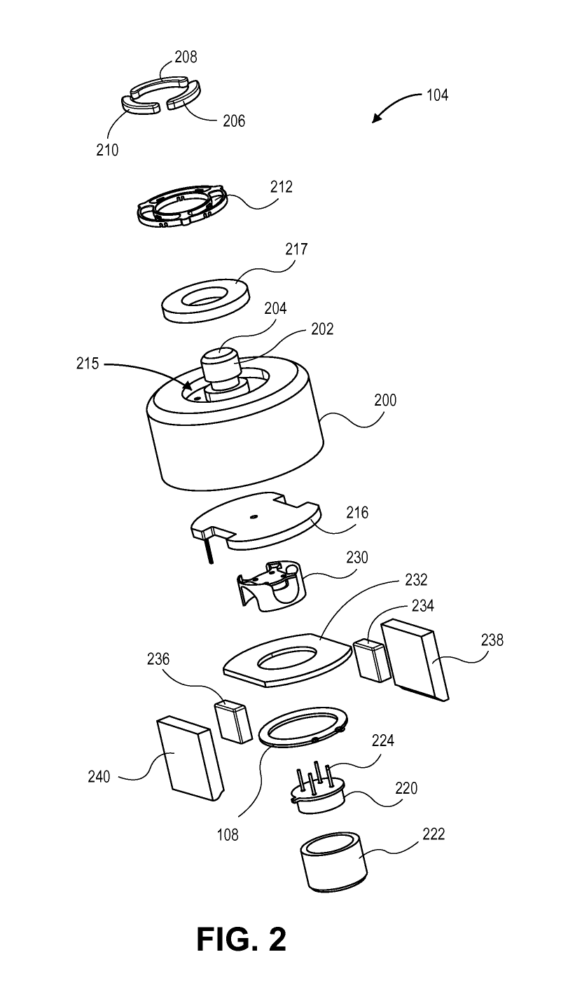

FIG. 2 illustrates an exploded view of the sensory head 104, according to an embodiment. It will be appreciated that the sensory head 104 displayed in FIG. 2 is but one specific example among many contemplated. As shown, the sensory head 104 includes a body shell 200, which may provide a rugged exterior for the sensory head 104. The sensory head 104 may also include a mounting device 202, such as a threaded stud, “quick-release” shaft, threaded opening, quick-release shaft collar, tabs, magnet, or any other device for mounting the sensory head 104 to the mobile unit 102. Accordingly, the mobile unit 102 (e.g., FIG. 1) may include a receptacle, such as a female threaded connection, quick connect shaft or collar, magnet, etc., for receiving and coupling with the mounting device 202.

The sensory head 104 may also include a ground connection 204, which may be integrated into the mounting device 202. The ground connection 204 may be electrically connected with the mobile unit 102. Accordingly, using the mounting device 202, the sensory head 104 may be placed into electro-mechanical communication with the mobile unit 102 and/or quickly removed from such communication therewith.

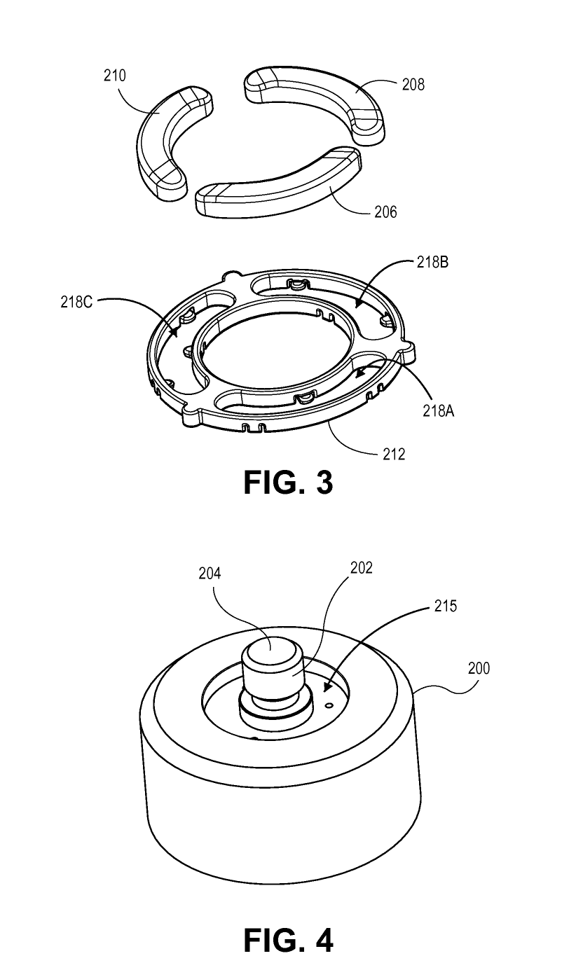

Several elements of the sensory head 104 embodiment depicted in FIG. 2 will now be described with reference to enlarged views thereof provided in FIGS. 3-6. Reference is thus made to each of FIGS. 3-6 individually, with continuing reference to the context provided by the illustrated embodiment of FIG. 2.

The sensory head 104 may include at least one contact (three are shown: 206, 208, 210) and an isolator ring 212. FIG. 3 illustrates an enlarged, perspective view of the contacts 206-210 and the isolator ring 212, according to an embodiment. As shown, the contacts 206-210 may be formed as arc-shaped members. The isolator ring 212 may include slots 218A, 218B, 218C, which may receive the contacts 206-210, respectively. The isolator ring 212 may thus serve to electrically isolate the contacts 206-210 from one another.

In an embodiment, the contact 206 may be configured to deliver power from the mobile unit 102 to the sensory head 104. The contact 208 may be configured to deliver a digital input signal from the mobile unit 102 to the sensory head 104. The contact 210 may be configured to deliver a digital output signal to the mobile unit 102, e.g., based on a signal from the sensory head 104. Although not depicted, in another embodiment, a fourth contact may be provided and seated within a slot of the isolator ring 212, for providing a communication signal from an identification reader (e.g., antenna) to the mobile unit 102, as will be described below.

FIG. 4 illustrates an enlarged, perspective view of the body shell 200, according to an embodiment. As mentioned above, the body shell 200 may include the mounting device 202 and the ground connection 204. The shell body 200 may also include a recess 215, which may be defined at least partially around the mounting device 202. The contacts 206-210 and the isolator ring 212 may seat in the recess 214; however, in other embodiments, the contacts 206-210 and shell body 200 may be coupled together, or otherwise positioned, in any other manner. Further, the contacts 206-210 and isolator ring 212 may be disposed in or “potted” in a resin 217, or another material, which may provide a stable and, for example, electrically-insulating mount for the contacts 206-210 and isolator ring 212 in the recess 215.

The sensory head 104 may further include an ultrasonic thickness sensor 220 and a hood 222. The hood 222 may cover at least a portion of the sensor 220, thereby shielding it from the surrounding environment. FIG. 6 illustrates an enlarged, exploded, perspective view of the sensor 220 and the hood 222, according to an embodiment. As shown, the sensor 220 may be physically coupled with at least one of a plurality of leads 224. For example, the sensor 220 may receive power and/or one or more digital communication signals via the leads 224 and provide a digital signal via another one of the leads 224. The leads 224 may, in turn, be electrically connected with a controller 216 and/or the contacts 206-210, and eventually with the mobile unit 102 (FIG. 1).

Referring now again specifically to FIG. 2, the sensory head 104 may also include an identification reader 108. The identification reader 108 may be configured to detect an identifier from the identification tag 110 (FIG. 1), as noted above. Accordingly, in an RFID embodiment, the identification reader 108 may be an RFID antenna (e.g., an active or passive RFID reader), and may include a tuned, wire loop, which may receive a modulated radio frequency signal from the RFID tag. The received radio frequency signal may provide data representing the identifier associated with the RFID tag. In active-reader embodiments, the identification reader 108 may also transmit a signal to the RFID tag, providing the energy for the signal carrying the identifier. In other embodiments, the identification reader 108 may be an optical sensor, which may read a QR code or a bar code provided by the identification tag 110, or may be any other type of sensor configured to receive information from the identification tag 110. In an embodiment, at least one of the contacts 206-210 may transmit the read tag information through a digital output signal, and out of the sensory head 104 into the mobile unit 102.

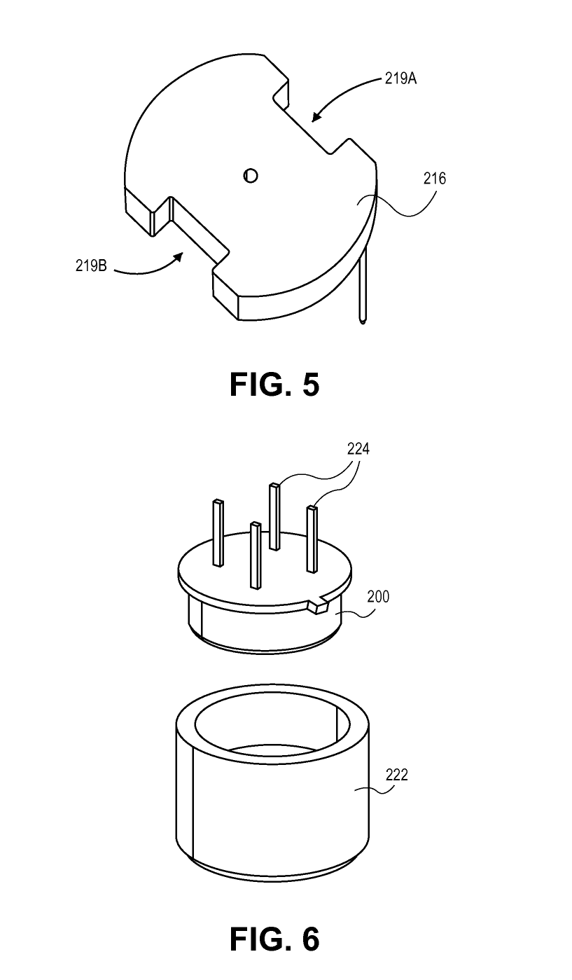

The controller 216, coupled with the leads 224 as noted above, may control operation of, including the power supply to, the sensory head 104, among other functions. FIG. 5 illustrates an enlarged view of the controller 216, according to an embodiment. The controller 216 may be or include one or more printed circuit boards (PCBs). In at least some embodiments, the controller 216 may include one or more microprocessors, electrical contacts/leads, electrical pathways, etc. The controller 216 may be in electrical communication with one or more of the contacts 206-210, as well as the ground connection 204.

Further, the controller 216 may define one or more magnet slots 219A, 219B, which may be formed as cut-outs extending inwards from the periphery of the controller 216. The controller 216 may be configured to selectively power the various elements of the sensory head 104, receive information therefrom, transmit information to the mobile unit 102, and/or otherwise control a functioning of the sensory head 104.

The sensory head 104 may also include a support assembly for the identification reader 108. For example, the support assembly may include a reader spacer 230 around which the identification reader 108 (e.g., a loop-shaped antenna) may be received, and a reader plate 232, which may couple with the identification reader 108 and the controller 216, so as to position the identification reader 108 with respect thereto. In some embodiments, however, the identification reader 108 may be or include an RFID spiral antenna or a wound inductor antenna, which may be coupled with the reader plate 232.

The sensory head 104 may also include one or more mounting feet (two are shown: 238, 240). The mounting feet 238, 240 may be fabricated at least partially of a highly-permeable material, which may transmit the magnetic flux generated by the magnets 234, 236. Further, the mounting feet 238, 240 may, in at least some embodiments, extend beyond the hood 222 so as to physically contact the test piece 106. In other embodiments, the mounting feet 238, 240 may not extend past the hood 222 and may, instead, be housed therein, transmitting the magnetic flux therethrough. Moreover, it will be appreciated that the magnets 234, 236 and/or mounting feet 238, 240 may be provided in any suitable shape and configuration, with the illustrated embodiment being merely one among many contemplated. Furthermore, in some embodiments, the magnets 234, 236 may be configured to bear directly on the test piece 106, with the mounting feet 238, 240 being omitted. In still other embodiments, the magnets 234, 236 and the mounting feet 238, 240 may be unnecessary and omitted.

Referring again to FIGS. 1 and 2, in an example of operation, the mobile unit 102 may be brought into proximity of the identification tag 110 (e.g., RFID tag). The identification reader 108 may read an identifier from the identification tag 110. For example, the identification reader 108 may poll for identification tags to read, e.g., by sending a signal constantly or intermittently. A preliminary trigger may also be provided to initiate such polling, such as a signal from the remote device 101, the controller 216 detecting the magnets 234, 236 engaging the test piece 106, or another trigger. In other embodiments, the identification reader 108 may be energized manually via user input to seek an identification tag 110 to read (e.g., to begin transmitting an energizing radio-frequency signal). In still other embodiments, the identification reader 108 may automatically detect proximity to an identification tag 110 in any other way.

The controller 216 may detect when the identification reader 108 reads a signal from the identification tag 110. In response, the controller 216 may cause the sensor 220 to begin the ultrasonic thickness measurement process. In a specific embodiment, the controller 216 may provide power to the sensor 220 and receive data therefrom, e.g., via the leads 224. In some embodiments, the controller 216 may be operable independently to cause the sensor 220 to commence measuring. In other embodiments, the controller 216 may interface with a separate controller housed in the mobile unit 102, the remote device 101, or elsewhere, for initiation of the thickness measuring.

In some embodiments, in addition to or instead of initiating measurement when the identification reader 108 reads an identifier, the controller 216 may be configured to detect when the magnets 234, 236 magnetically engage the test piece 106, e.g., via the mounting feet 238, 240. In some embodiments, the controller 216 (or another part of the mobile unit 102 and/or remote device 101) may be responsive to a user input, e.g., a user pressing a button on the mobile unit 102 and/or remote device 101, and may initiate thickness measurements in response to such manual input.

When the identification reader 108 obtains an identifier from the identification tag 110, the sensory head 104 (e.g., the controller 216) may provide a signal to the mobile unit 102 that includes a digital representation of the identifier. The mobile unit 102 may, in some embodiments, relay the identifier to the remote device 101. In some embodiments, the remote device 101 and/or the mobile unit 102 may query a database, using the obtained identifier, so as to determine the location-specific information associated with the test location 112 of the test piece 106. The mobile unit 102 and/or the remote device 101 may then use this information to assist in calibration of sensor data, and/or analysis thereof.

Furthermore, the recorded measurement(s) from the sensor 220 may be stored in association with the identifier. The identifier, which may be linked to a machine and/or the specific location 110, may thus provide an index to a history of measurements, which may be updated each time the thickness of the test piece 106 is measured in response to a particular identifier being read.

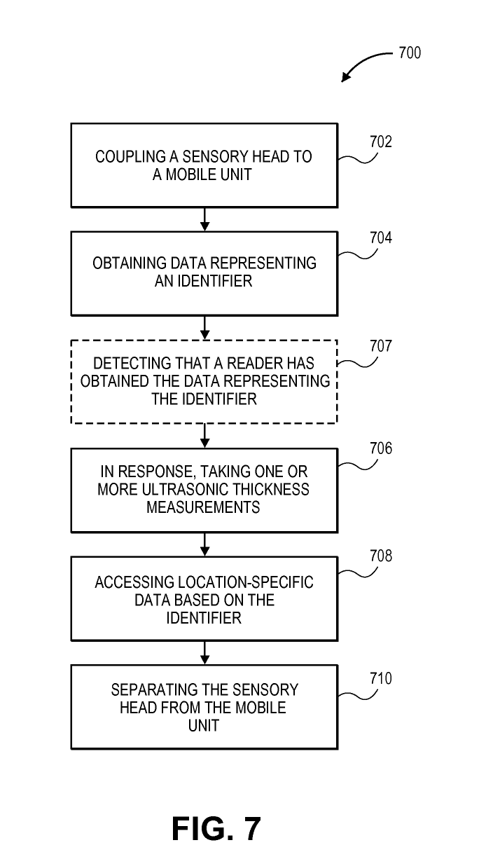

FIG. 7 illustrates a flowchart of a method 700 for measuring a thickness of a test piece, according to an embodiment. The method 700 may proceed by operation of one or more embodiments of the sensor system 100 described above; however, at least some embodiments of the method 700 are not limited to any particular structure.

The method 800 may include coupling a sensory head to a mobile unit, as at 702. In such coupling, the sensory head may receive power and/or an input signal from the mobile unit. Further, the sensory head may supply a communication signal to the mobile unit. In some embodiments, the sensory head may include a controller, an identification reader coupled with the controller, and an ultrasonic thickness sensor coupled with the controller.

The method 700 may also include obtaining data representing an identifier from an identification tag positioned on or proximal to a test location of a test piece, using the identification reader, as at 704. In one specific example, the identification tag may be an RFID tag, active or passive, which may be readable and/or writable by interface with the identification reader, which may be an RFID tag reader, whether active or passive. In other embodiments, other types of identification readers and tags may be employed.

The method 700 may further include, in response to obtaining the data representing the identifier, taking one or more thickness measurements using the ultrasonic thickness sensor, as at 706. In an example, the controller may detect when the identification reader has obtained the data representing the identifier, as at 707. The controller may then respond by energizing a transmitter of the ultrasonic thickness sensor, as well as a receiver thereof, so as to begin the thickness measurement. The controller may then, in at least some embodiments, receive a signal from the ultrasonic thickness sensor, with the signal representing the time between when the ultrasonic pulse was emitted and when it was received, which may be converted to a thickness measurement. The controller may then relay the signal, or an interpretation thereof, to the mobile unit for further processing, display, and/or transmission to a remote device in communication (e.g., wirelessly) with the mobile unit.

In an embodiment, the method 700 may optionally include accessing location-specific data related to the test location of the test piece based on the identifier, as at 708. For example, the location-specific data may be stored, in association with one or more identifiers, in a database that may be stored on the mobile unit, or the remote device. The location-specific data may include, for example, material properties of the test piece, specifically at the location associated with the identifier (which may be the location at which the identification tag is disposed). The location-specific data may then be used (e.g., after being transmitted from the remote device) by the mobile unit and/or the sensory head, so as to calibrate the data received from the sensor and/or determine a health, integrity, remaining lifespan, etc. of the test piece, based on the thickness thereof and/or of any prior thickness measurements thereof.

In an embodiment, the connection between the mobile unit and the sensory head may be releasable without damaging either. For example, multiple sensory heads, e.g., with multiple different types and/or sizes of sensors may be provided as modular units. Accordingly, the

While the present teachings have been illustrated with respect to one or more implementations, alterations and/or modifications may be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A sensory apparatus for ultrasonic thickness measurement, comprising:
an ultrasonic thickness sensor;
an identification reader configured to acquire data representing an identifier from an identification tag; and
a controller coupled with the ultrasonic thickness sensor and the identification reader, wherein, in response to the identification reader acquiring the data representing the identifier, the controller causes the ultrasonic thickness sensor to measure a thickness of a test piece.

2. The apparatus of claim 1, wherein the identification reader comprises an RFID antenna.

3. The apparatus of claim 1, wherein the identification reader comprises a bar-code scanner, a QR-code scanner, or a combination thereof.

4. The apparatus of claim 1, further comprising a shell body into which the identification reader and the controller are at least partially received, the shell body comprising a mounting device configured to be removably coupled with a mobile unit.

5. The apparatus of claim 4, wherein the shell defines a recess therein, the apparatus further comprising one or more electrical contacts received into the recess and electrically coupled with the controller, the one or more electrical contacts being configured to electrically communicate with the mobile unit, when the mounting device is coupled therewith.

6. The apparatus of claim 5, wherein the recess extends at least partially around the mounting device.

7. The apparatus of claim 1, further comprising one or more magnets, the one or more magnets being configured to mechanically engage the test piece.

8. The apparatus of claim 7, wherein the controller is configured to detect when the one or more magnets magnetically engage the test piece.

9. A sensor system, comprising:
a mobile unit comprising a power source; and
a sensory head releasably coupled with the mobile unit, such that the sensory head is in electrical communication with the mobile unit so as to receive power from the power source and to provide a communication signal to the mobile unit, wherein the sensory head comprises:
an ultrasonic thickness sensor configured to generate a signal representing of a thickness of a test piece;
an identification reader configured to obtain data representing an identifier from an identification tag located external to the sensory head; and
a controller coupled with the ultrasonic thickness sensor and the identification reader, wherein the controller is configured to initiate the ultrasonic thickness sensor in response to the identification reader obtaining the data representing the identifier.

10. The sensor system of claim 9, wherein the identification reader comprises a radio-frequency identification (RFID) tag reader, and the identification tag comprises an RFID tag.

11. The sensor system of claim 9, wherein the controller is configured to supply data representing the identifier to the mobile unit, and wherein the mobile unit is configured to determine location-specific data associated with the test piece, based on the identifier.

12. The sensor system of claim 9, further comprising a remote device in communication with the mobile unit, wherein the controller is configured to supply data representing the identifier to the mobile unit, the mobile unit is configured to supply data representing the identifier to the remote device, and the remote device is configured to determine location-specific data related to the test piece, based on the identifier.

13. The sensor system of claim 9, wherein the sensory head comprises a body shell in which the ultrasonic thickness sensor, the identification reader, and the controller are at least partially received, wherein the body shell comprises a mounting device configured to releasably couple with the mobile unit.

14. The sensor system of claim 13, wherein the mounting device comprises a threaded shaft configured to be threaded the mobile unit.

15. The sensor system of claim 14, wherein the body shell defines a recess extending at least partially around the mounting device, the sensory head further comprising one or more electrical contacts received into the recess and configured to electrically communicate with the mobile unit, when the sensory head is coupled with the mobile unit.

16. A method for measuring thickness, comprising:
coupling a sensory head to a mobile unit such that the sensory head receives at least power from the mobile unit and supplies a communication signal to the mobile unit, wherein the sensory head includes a controller, an identification reader coupled with the controller, and an ultrasonic thickness sensor coupled with the controller;
obtaining data representing an identifier from an identification tag positioned in, on, or proximal to a test location of a test piece, using the identification reader; and
in response to obtaining the data representing the identifier, taking one or more thickness measurements using the ultrasonic thickness sensor.

17. The method of claim 16, further comprising accessing location-specific data related to the test location of the test piece based on the identifier.

18. The method of claim 17, further comprising calibrating the ultrasonic thickness sensor based on the location-specific data.

19. The method of claim 17, further comprising transmitting a signal representing the identifier from the mobile unit to a remote device, wherein accessing the location-specific data comprises querying a database stored on the remote device.

20. The method of claim 17, further comprising detecting, using the controller, that the identifier has been obtained, wherein taking the one or more thickness measurements comprises sending a signal from the controller to the ultrasonic thickness sensor when the controller detects the identifier has been obtained.
